(19) United States
(12) Patent Application Publication
(10) Pub. No.: US 2015/0351177 A1
(43) Pub. Date: Dec. 3, 2015

(54) SOLAR ENERGY HARVESTING WITH LIGHT EMITTING DIODES

(71) Applicant: Purdue Research Foundation, West Lafayette, IN (US)

(72) Inventor: Walter Daniel Leon-Salas, West Lafayette, IN (US)

(73) Assignee: PURDUE RESEARCH FOUNDATION, West Lafayette, IN (US)

(21) Appl. No.: 14/726,447

(22) Filed: May 29, 2015

Related U.S. Application Data
(60) Provisional application No. 62/004,870, filed on May 29, 2014.

(51) Int. Cl. H05B 33/08; G09G 3/32; G09F 13/22; H05B 37/02

(52) U.S. Cl. CPC H05B 33/0815; H05B 37/0272; G09G 3/3208; G09F 13/22; G09G 2330/00; G09G 2300/026; G09F 2013/222

(57) ABSTRACT

An apparatus having a plurality of photonic devices electrically coupled to each other, each photonic device selectively configured to operate in a first mode as a light generating device when an electrical current is provided to the device by converting electrical energy to light. The device is further configured to operate in a second mode as a photovoltaic cell when no electrical current is provided to the device by converting light to electrical energy. A switching network coupled to the plurality of photonic devices. Each switch in the switching network may be configured to allow selection of the first or second mode for a respective photonic device of the plurality of photonic devices. The switching network may be coupled to a bi-direction DC-DC converter.

### RELATED APPLICATIONS

The present application claims the benefit of U.S. provisional application Ser. No. 62/004,870, filed May 29, 2014, the contents of which are hereby incorporated by reference in its entirety.

### STATEMENT OF GOVERNMENT INTEREST

This invention was made with government support under ECCS-1055169 awarded by the National Science Foundation. The government has certain rights in the invention.

### TECHNICAL FIELD

The present application relates to electronic displays, and particularly to electronic displays which employ light emitting diodes.

### BACKGROUND

Many electronic displays employ light emitting diodes (LEDs) as output elements for displaying information, such as text, pictures, or video. Such displays require electric power to drive the display and/or other peripheral devices. Because the displays are often located in remote areas without access to electric grid power, expensive portable power systems (e.g., battery packs or portable generators) are needed. Handheld devices with electronic displays also suffer from increased size and weight due to the need for large batteries. Therefore, there is a need in the art to reduce the external power requirements for such displays and devices.

### SUMMARY

According to one aspect, an apparatus is disclosed comprising a plurality of photonic devices electrically coupled to each other, each photonic device selectively configured to operate in a first mode as a light generating device when an electrical current is provided to the device by converting electrical energy to light. The device is further configured to operate in a second mode as a photovoltaic cell when no electrical current is provided to the device by converting light to electrical energy. A switching network is coupled to the plurality of photonic devices, each switch in the switching network configured to allow selection of the first or second mode for a respective photonic device of the plurality of photonic devices.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a simplified cross-section diagram of a conventional hetero-junction light emitting diode.

FIG. 2 is a plot illustrating the operating regions of a light emitting diode.

FIG. 3 is a schematic diagram of a bidirectional buck-boost DC-DC converter for transferring energy between an LED and a battery according to one embodiment.

FIG. 4 is a schematic diagram of an equivalent circuit of the converter of FIG. 3 during an inductor charging phase.

FIG. 5 is a schematic diagram of an equivalent circuit of the converter of FIG. 3 during an inductor discharging phase.

FIG. 6 is a schematic diagram of a LED energy harvesting system having a buck-boost converter connected to an array of LEDs through a switching matrix according to one embodiment.

The attached drawings are for purposes of illustration and are not necessarily to scale.

### DETAILED DESCRIPTION

Throughout this description, some aspects are described in terms that would ordinarily be implemented as software programs. Those skilled in the art will readily recognize that the equivalent of such software can also be constructed in hardware, firmware, or micro-code. Because data-manipulation algorithms and systems are well known, the present description is directed in particular to algorithms and systems forming part of, or cooperating more directly with, systems and methods described herein. Other aspects of such algorithms and systems, and hardware or software for producing and otherwise processing signals or data involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

In its basic form an LED is a p-n junction typically made of direct-gap semiconductors such GaAs, GaN, InP or GaAsP. Light is generated in LEDs by injection electro-luminescence in which electrons are injected into the p-region and holes are injected into the n-region of a p-n junction under a forward bias. Electrons and holes recombine radiatively generating photons. To improve the photon-generation efficiency, virtually all LEDs use a hetero-junction structure. A hetero-junction structure consists of two types of semiconductors: a small-bandgap semiconductor and a large-bandgap semiconductor. The purpose of using semiconductors of different bandgaps is to confine or concentrate the injected carriers into a region called the active region. A high concentration of carriers in the active region increas a radiative electron-hole recombination.

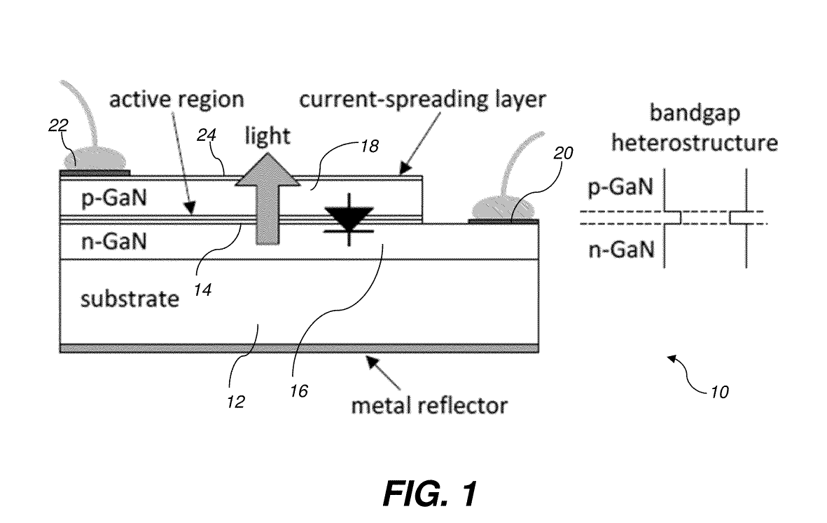

FIG. 1 shows the cross-section of a solid-state LED 10. The LED 10 is epitaxially grown on a transparent substrate 12, typically sapphire, although other materials may be used. The active region 14 is grown on top of an n-type GaN layer 16 and a p-type GaN layer 18 is grown on top of the active region 14. GaN has a larger bandgap than the active region material and forms a confinement layer. The active region 14 is a p-n junction of a small-bandgap semiconductor such as AlInGaP or GaInAsP. To improve the internal quantum efficiency of an LED, the active region thickness is preferably limited to a few tenths of a micrometer (between 0.15 to 0.75).

Part of the p-type GaN layer 16 and the active region 14 is etched to create a bond-wire contact 20. The other contact 22 is made at the top of the p-type GaN layer 18. To improve the limited conductivity of the p-type GaN layer, a thin metallic current-spreading layer 24 is deposited on top of the p-type GaN layer.

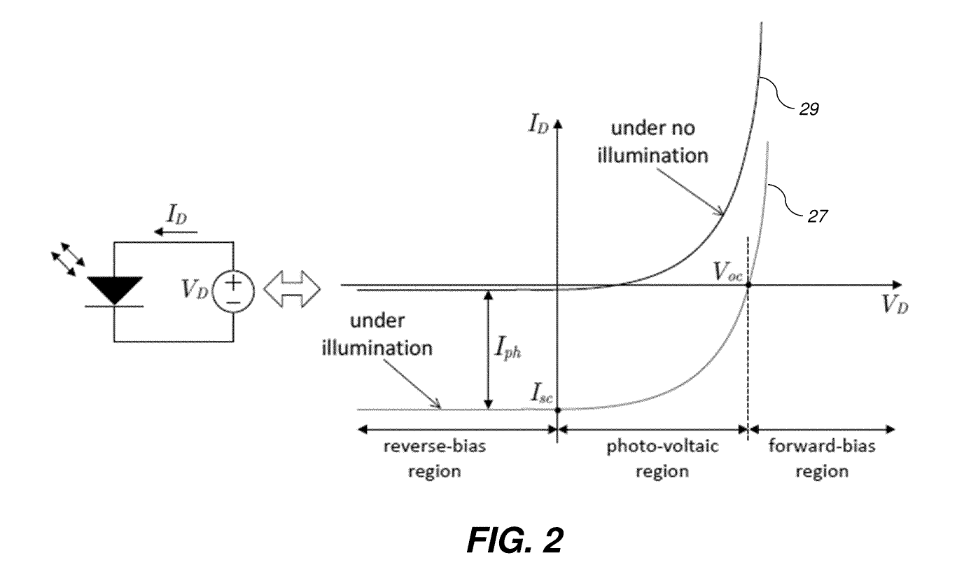

The present disclosure utilizes the phenomena that LEDs are dual devices. On one hand, they emit light when electrons and holes recombine generating photons. On the other hand, when photons with energy larger than the bandgap of the semiconductor material strike the LED, electron-hole pairs are generated giving rise to a photo-current. This dual behavior can be observed in the current-vs-voltage (I-V) curve of an LED such as LED 10. FIG. 2 shows a typical I-V curve of an LED under illumination (curve 27) and no-illumination (curve 29) conditions.

Notably, the I-V curve shifts downward by the photo-generated current Iₚₕ creating three distinctive regions of operation: the reverse-bias region, the photo-voltaic region and the forward-bias region. LEDs that operate in the forward-bias region emit light due to radiative recombination of the injected carriers. The LED dissipates energy both in the forward-bias and reverse-bias regions. However, in the photo-voltaic region the LED generates energy, i.e. the diode's current, I_{D}, flows out of the anode, and the voltage across the diode, V_{D}, is positive. Therefore, in principle, an LED can be employed to generate (harvest) energy from light if it operates in the photo-voltaic region.

The structure of an LED is optimized to generate photons efficiently and to extract them outside the device. For instance, the active region is very thin to improve the internal quantum efficiency and barriers are created in the energy band to confine charges to certain regions. Moreover, the area of a typical indicator LED is limited to 0.35 to 1 mm³. High-power LEDs have larger active areas but are still much smaller than a typical solar cell. As a result an LED is not very efficient at absorbing photons and producing a photo-generated current. However, there are applications where several hundreds or thousands of LEDs are installed outdoors in electronic displays or billboards (or in electronic displays in handheld devices) and whose installation and fabrication costs are already covered. These LEDs represent a resource that can be exploited to harvest solar energy.

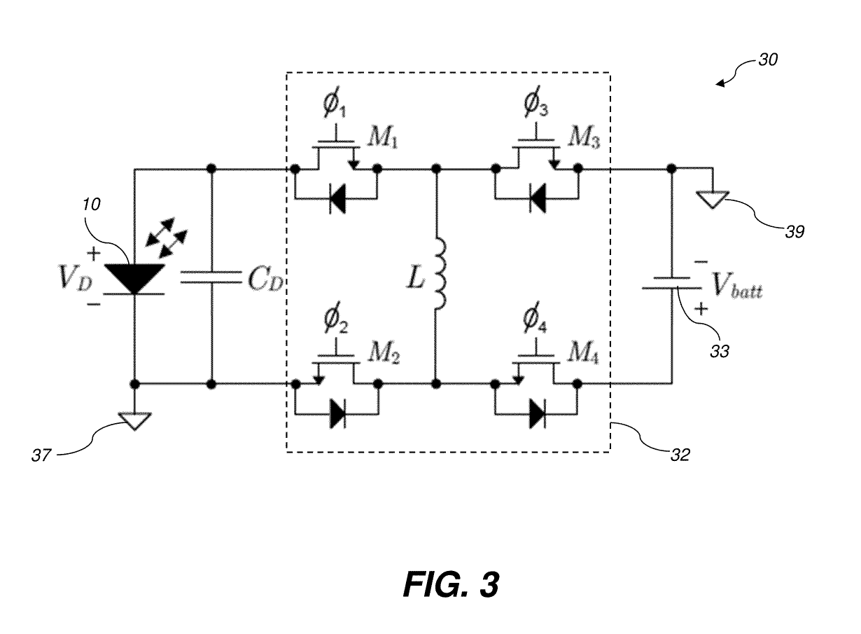

FIG. 3 illustrates a system 30 according to one embodiment of the present disclosure, wherein one or more LEDs 10 are utilized both as light emitters and as energy harvesters. Under this paradigm, an LED 10 becomes both a sink and a source of energy; a sink when it works in the forward-bias region (current flows out of the cathode of the LED 10) emitting light and as a source when it works in the photo-voltaic region (current flows out of the anode of the LED 10) generating power. To operate the LED 10 in both regions in a display, a bidirectional DC-DC converter 32 is provided (e.g., a buck-boost converter). The function of the bidirectional DC-DC converter 32 is to transfer energy to and from the LED 10 and a battery 33 or another energy reservoir. Moreover, the DC- DC converter is able to buck and boost voltage in both directions to account for parallel or series-connected LED arrangements.

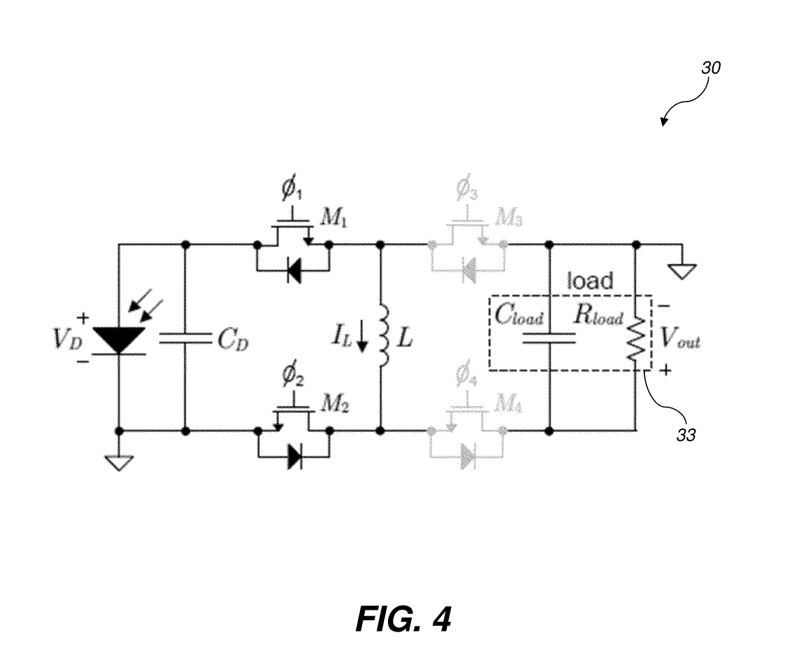

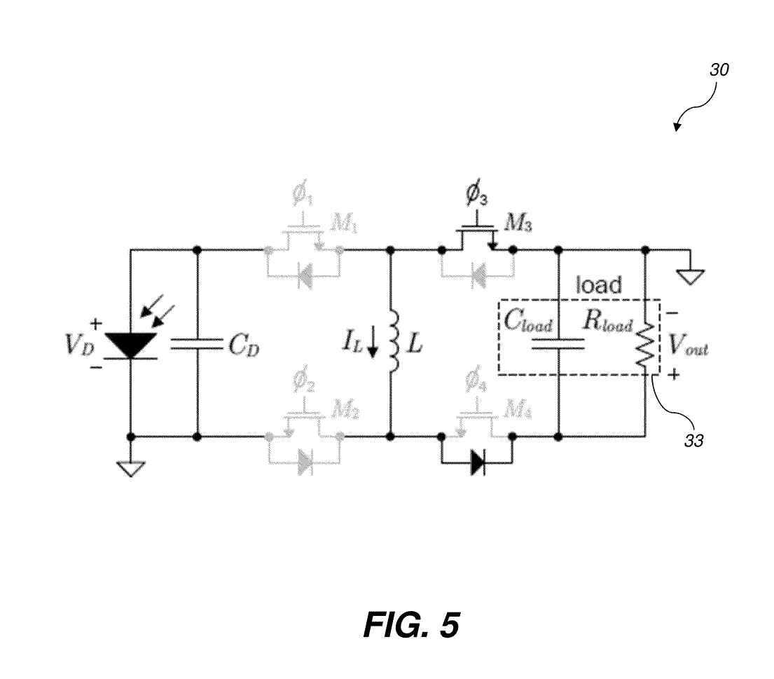

As shown in FIG. 3, the system 30 includes converter 32 having four MOSFETs (M₁ to M₄) and four corresponding diodes and works in two phases: phase 1 and phase 2. The converter 32 is able to buck and boost current in both directions. In one embodiment, the MOSFETs M₁ to M₄ comprise model NTS4409N transistors. C_{D} represents the capacitance of the LED 10. Grounds 37 and 39 may be optionally connected as shown. When energy needs to be transferred from the LED 10 to the battery 33 or load side (e.g., when LED 10 as acting in the photo-voltaic region as a solar energy harvester), the inductor L is charged by the LED in phase 1 by closing M₁ and M₂ and opening M₃ and M₄ (shown as light gray for open) as shown in FIG. 4. In phase 1, current flows out of the anode of LED 10, through M₁, through the inductor L, through M₂, and back to the cathode of LED 10. C_{load} represents the capacitance of the load (e.g., battery 33), and R_{load} represents the resistance of the load. In phase 2, the inductor L discharges into the load (e.g., battery 33) by closing M₃ while opening M₁ and M₂ (shown in light gray for open) as shown in FIG. 5. In this state, current flows from the inductor L, through the diode of M₄, through the load (e.g., battery 33), through M₃ and back to the inductor L. Likewise, when energy needs to be transferred from the battery 33 to the LED 10 side (e.g., when LED 10 is acting as a display output element), M₃ and M₄ are closed and M₁ and M₂ are open in phase 1 to charge the inductor L (current flows from through M₄, through the inductor L, through M₃, through the load (e.g., battery 33) and back to M₄); and in phase 2, M₂ is closed while M₃ and M₄ are open to discharge the inductor into the LED (current flows through M₂, through the inductor L, through the diode of M₁, through the diode 10 and back to M₂).

The duty cycle of the clock that controls the switches M₁-M₄ determines the voltage conversion ratio. Using a first-order approximation where the LED voltage is constant, it can be shown that:

$${V}_{out} = ( \frac{1 - D}{D} ) {V}_{D} \qquad ( 1 )$$

where, Vₒᵤₜ is the output voltage, D=T₂/(T₁+T₂) is the clock's duty cycle and T₁ is the duration of phase 1 and T₂ is the duration of phase 2. The DC-DC converter 30 boosts when D<0.5 and bucks when D>0.5.

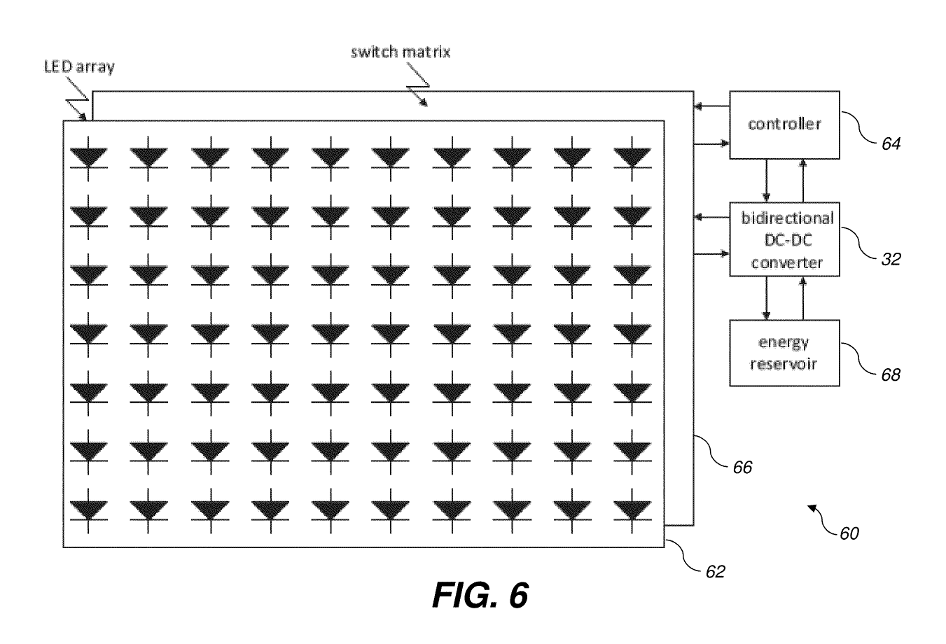

FIG. 6 shows a schematic of a system 60 having the converter 32 connected to an LED array 62 through a switching network (illustrasted as switch matrix 66). Controller 64 is also connected to the converter 32 and the switch matrix 66 to selectively harvest energy from individual LEDs in the array 62 which are not being used for display output at a given time, and to likewise output power to the LEDs which are desired to be driven for output. The harvested energy is stored in energy reservoir 68 (e.g., a battery or storage capacitor). The stored energy may be later used to drive the LEDs as needed.

The systems of FIG. 3 and FIG. 6 may be implemented within any device that includes an electronic display. Non limiting examples include outdoor billboard displays, outdoor electronic safety displays (e.g., construction or highway uses), mobile handheld devices, and indoor electronic displays.

Steps of various methods described herein can be performed in any order except when otherwise specified, or when data from an earlier step is used in a later step. Exemplary method(s) described herein are not limited to being carried out by components particularly identified in discussions of those methods.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

The systems 30 and 60, including controller 64, converter 32, and switch matrix 62 may include one or more electronic computer processors, memory, data storage devices, and input/output devices in order to achieve the functionality described above.

The invention is inclusive of combinations of the aspects described herein. References to “a particular aspect” (or “embodiment” or “version”) and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. An apparatus, comprising:
a plurality of photonic devices, each photonic device selectively configured to operate in a first mode as a light generating device when an electrical current is provided to the device by converting electrical energy to light; the device further configured to operate in a second mode as a photovoltaic cell when no electrical current is provided to the device by converting light to electrical energy; and
a switching network coupled to the plurality of photonic devices, each switch in the switching network configured to allow selection of the first or second mode for a respective photonic device of the plurality of photonic devices.

2. The apparatus of claim 1, a plurality of the plurality of photonic devices are light emitting diodes.

3. The apparatus of claim 1, the plurality of photonic devices are light emitting diodes.

4. The apparatus of claim 1, the switching network is coupled to a bi-direction DC-DC converter.

5. The apparatus of claim 4, the DC-DC converter is a buck-boost converter.

6. The apparatus of claim 4, wherein the converter comprises four switching devices connected to an inductor.

7. The apparatus of claim 6, wherein each of said switching devices comprise a transistor.

8. The apparatus of claim 7, wherein the transistor comprises a MOSFET.

9. The apparatus of claim 4, the converter is coupled to an energy reservoir.

10. The apparatus of claim 9, the energy reservoir is a capacitor.

11. The apparatus of claim 9, the energy reservoir is a battery.

12. The apparatus of claim 9, further comprising a wireless communication device
operatively connected to the energy reservoir, the wireless communication device
configured to receive information for output on the photonic devices.

13. An electronic handheld device, comprising:
an electronic display, the display including a plurality of photonic devices, each photonic device selectively configured to operate in a first mode as a light generating device when an electrical current is provided to the device by converting electrical energy to light; the device further configured to operate in a second mode as a photovoltaic cell when no electrical current is provided to the device by converting light to electrical energy;
a switching network coupled to the plurality of photonic devices, each switch in the switching network configured to allow selection of the first or second mode for a respective photonic device of the plurality of photonic devices;
a bi-direction DC-DC converter operatively coupled to the switching network; and
an energy reservoir operatively connected to the converter, the energy reservoir configured to provide power to the handheld device.

14. An outdoor display device, comprising:
an electronic display, the display including a plurality of photonic devices, each photonic device selectively configured to operate in a first mode as a light generating device when an electrical current is provided to the device by converting electrical energy to light; the device further configured to operate in a second mode as a photovoltaic cell when no electrical current is provided to the device by converting light to electrical energy;
a switching network coupled to the plurality of photonic devices, each switch in the switching network configured to allow selection of the first or second mode for a respective photonic device of the plurality of photonic devices; and
a bi-direction DC-DC converter operatively coupled to the switching network; and
an energy reservoir operatively connected to the converter, the energy reservoir configured to provide power to the display device.
